(19) United States
(12) Patent Application Publication
(10) Pub. No.: US 2011/0091183 A1
(43) Pub. Date: Apr. 21, 2011

(54) INFORMATION PROCESSING APPARATUS AND DATA TRANSFER METHOD

(75) Inventor: Seiichi Nakamura, Inagi-shi (JP)

(73) Assignee: Kabushiki Kaisha Toshiba, Tokyo (JP)

(21) Appl. No.: 12/909,729

(22) Filed: Oct. 21, 2010

(30) Foreign Application Priority Data
Oct. 21, 2009 (JP) 2009-242662

(51) Int. Cl. H04N 5/775

(52) U.S. Cl. 386/230; 386/E05.003

(57) ABSTRACT

According to one embodiment, an information processing apparatus is configured to play back video content data. The information processing apparatus comprises a display device and a control module. The display device is configured to display video of video content data being played back. The control module is configured to display a graphical user interface including a first button associated with the video content data being played back and a second button indicative of an electronic device on a screen of the display device, and to transfer the video content data, which is associated with the first button and is being played back, to the electronic device in response to a pointing operation by a user for associating the first button with the second button.

### CROSS-REFERENCE TO RELATED APPLICATIONS

This application is based upon and claims the benefit of priority from Japanese Patent Application No. 2009-242662, filed Oct. 21, 2009; the entire contents of which are incorporated herein by reference.

### FIELD

Embodiments described herein relate generally to an information processing apparatus, such as a personal computer playing back video content, and a data transfer method applied to this apparatus.

### BACKGROUND

In recent years, it has been widely practiced to view, with use of a browser of a personal computer, various video contents, such as video clips or home movies available on a video delivery site on the Internet. A video playback program embedded in the browser as plug-in software decodes the video content data received from the video delivery site. Video of the decoded video content data is displayed on a display under the control of the operating system.

In addition, recently, techniques have begun to be developed for sharing video contents between electronic devices in the home.

In computer networks, as schemes for sharing data between computers, there are known techniques such as so-called “network drive” and “shared folder”. However, in the case of sharing video contents between electronic devices in the home, it is desirable to realize a novel interface which enables transfer of a target content to a target electronic device simply by a user's intuitive operation.

As interfaces for supporting user operations, graphical user interfaces are widely known. Jpn. Pat. Appln. KOKAI Publication No. 2002-108543 discloses a graphical user interface for realizing a software keyboard.

However, the graphical user interface of KOKAI Publication No. 2002-108543 is intended to support input of character codes, and no consideration is given to supporting data sharing and data exchange between devices.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 shows a structure example of a home network system comprising an information processing apparatus according to an embodiment;

FIG. 2 illustrates a state in which while the information processing apparatus of the embodiment is playing back content data, this content data is played back by an electronic device such as a TV;

FIG. 3 is a block diagram showing an example of the system configuration of the information processing apparatus according to the embodiment;

FIG. 4 is a block diagram showing an example of a software configuration for realizing a streaming function of the information processing apparatus according to the embodiment;

FIG. 5 illustrates an example of a browser window comprising a video display area displayed by a browser on a display screen of the information processing apparatus according to the embodiment;

FIG. 6 illustrates an example of a graphical user interface (GUI) layer used in the information processing apparatus according to the embodiment;

FIG. 7 is a view for describing the GUI displayed by the information processing apparatus according to the embodiment;

FIG. 8 is a view for describing a first button and a plurality of second buttons in the GUI displayed by the information processing apparatus according to the embodiment;

FIG. 9 is a view showing a state in which the first button is displayed on the screen of the information processing apparatus according to the embodiment;

FIG. 10 is a view illustrating an example of the layout of a plurality of second buttons displayed on the screen of the information processing apparatus according to the embodiment;

FIG. 11 is a view illustrating another example of the layout of a plurality of second buttons displayed on the screen of the information processing apparatus according to the embodiment;

FIG. 12 is a view illustrating still another example of the layout of a plurality of second buttons displayed on the screen of the information processing apparatus according to the embodiment;

FIG. 13 is a view for describing drop areas associated with the second buttons in the GUI displayed by the information processing apparatus according to the embodiment;

FIG. 14 shows a state in which a transfer-destination device has been selected in response to a user operation on the GUI displayed by the information processing apparatus according to the embodiment;

FIG. 15 is a flow chart illustrating the procedure of a streaming process executed by the information processing apparatus according to the embodiment;

FIG. 16 is a flow chart illustrating the procedure of a GUI display process executed by the information processing apparatus according to the embodiment; and

FIG. 17 is a flow chart illustrating the procedure of a second button selection process executed in the GUI display process illustrated in FIG. 16.

### DETAILED DESCRIPTION

Various embodiments will be described hereinafter with reference to the accompanying drawings.

In general, according to one embodiment, an information processing apparatus is configured to play back video content data. The information processing apparatus comprises a display device and a control module. The display device is configured to display video of video content data being played back. The control module is configured to display a graphical user interface comprising a first button associated with the video content data being played back and a second button indicative of an electronic device on a screen of the display device, and to transfer the video content data, which is associated with the first button and is being played back, to the electronic device in response to a pointing operation by a user for associating the first button with the second button.

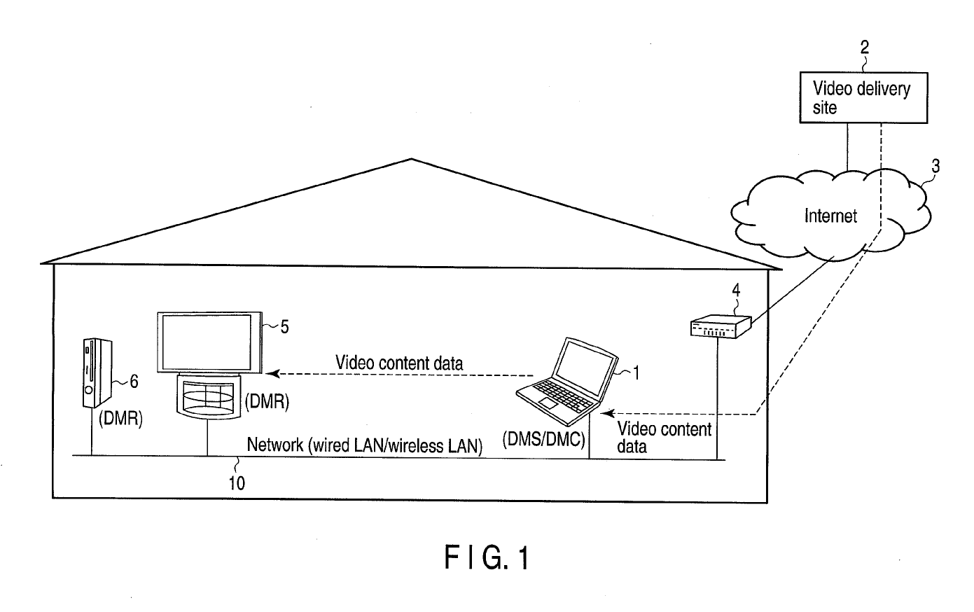

FIG. 1 shows a structure example of a network system comprising an information processing apparatus according to an embodiment. This network system is a home network for interconnecting various electronic devices in the home, such as a consumer device, a portable device and a personal computer. The information processing apparatus is realized, for example, as a notebook-type personal computer (PC) 1.

The personal computer (PC) 1 is connected to a network 10 in order to communicate with other electronic devices in the home. The network 10 is composed of, for example, a wired LAN or a wireless LAN. A TV 5, a game machine 6 and other various electronic devices are connected to the network 10.

Furthermore, a communication device 4, such as a broadband modem or a broadband router, is connected to the network 10. The personal computer 1 can access Web sites on the Internet 3 via the communication device 4. The Web sites comprise a video delivery site 2 for sharing video content data, such as home video created by users. The video delivery site 2 makes public various video content data, such as video clips and home video uploaded by users. The user of the personal computer 1 can play back, while receiving via the Internet 3, video content data which can be provided by the video delivery site 2. The access to the video delivery site 2 is executed by software, for example, a browser (WWW browser) executed by the computer 1. The video content data on the video delivery site 2 comprises various video content data encoded by various encoding schemes. The reception and playback of the video content data from the video delivery site 2 are executed, for example, by a video playback program plugged in the browser. This video playback program is player software for decoding the encoded video content data received from a server such as the video delivery site 2. The video of the video content data, which has been decoded by the video playback program, is displayed on the display device of the personal computer 1 under the control of the operating system.

The reception and playback of video content data are executed, for example, by using streaming. The video playback program, while receiving video content data from the video delivery site 2, decodes the received video content data.

The computer 1 has a UPnP (universal plug and play) function for recognizing the presence of devices on the network 10, and exchanging their functions (capabilities). Further, by using the UPnP function, the computer 1 can function as a home network device which is stipulated, for example, by the guideline of DLNA (Digital Living Network Alliance). Home network devices are classified into categories of, for instance, a digital media server (DMS), a digital media player (DMP), a digital media controller (DMC) and a digital media renderer (DMR).

The digital media server (DMS) is a device providing content data stored in a storage unit in the digital media server (DMS) to the digital media player (DMP) in response to a request from a digital media player (DMP). The digital media controller (DMC) is a device controlling a device such as a digital medial renderer (DMR). The digital media renderer (DMR) is a device playing back content data received from the digital media server (DMS), under the control of the digital media controller (DMC). The content data, which is to be received and played back by the digital media renderer (DMR), is instructed to the digital media renderer (DMR) by the digital media controller (DMC).

The computer 1 can function as both the digital media server (DMS) and the digital media controller (DMC). Each of the TV 5 and game machine 6 can function as the digital media renderer (DMR).

In addition, the computer 1 of the embodiment has a function (hereinafter referred to as “streaming function”) of providing, while receiving video content data from the video delivery site 2, the video content data in real time to the digital media renderer (DMR), for instance, the TV 5 or game machine 6. The streaming function enables the user to search desired content from the video delivery site 2 on the Internet 3 by making use of a computer with a high operability with respect to Internet browsing, and to display the searched content on the large screen of the TV 5. In the meantime, not only the content received from the video delivery site 2 but also the content stored in the computer 1 can be transferred to the TV 5 and played back.

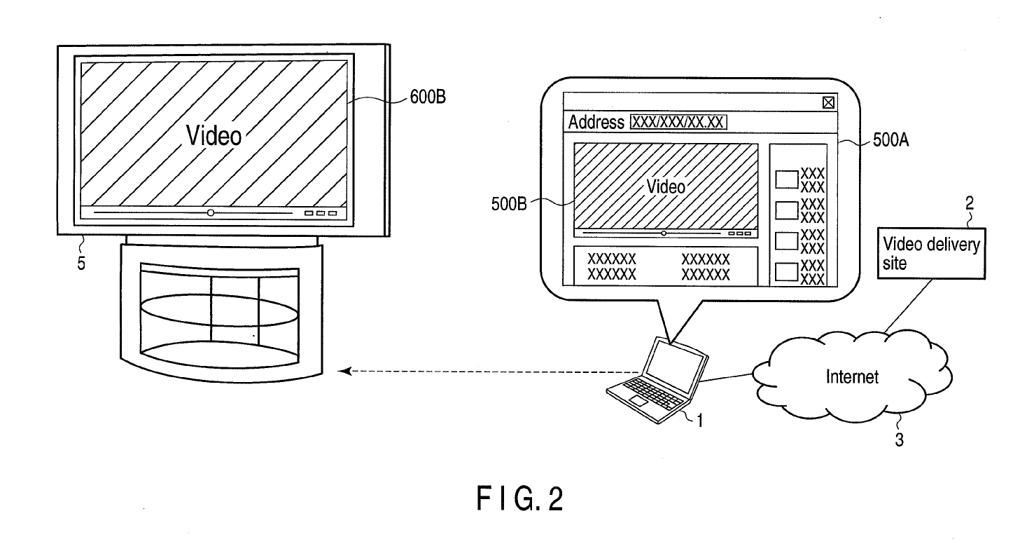

FIG. 2 illustrates a state in which while the computer 1 is receiving content data from the video delivery site 2, the video content data is played back by the electronic device such as the TV 5.

The screen of the display of the computer 1 displays a window 500A of the browser. As has been described above, the decode and playback of the video content data, which is received from the video delivery site 2, are executed by the video playback program plugged in the browser. The video content data comprises, for instance, encoded video data and encoded audio data. The video playback program decodes the video data and audio data and outputs the decoded video data and audio data. Video corresponding to the decoded video data is displayed on a video window 500B disposed within the window 500A of the browser. Needless to say, the video window 500B can be displayed in a full-screen mode on the display screen of the computer 1.

If an event instructing execution of the streaming function occurs in response to a user operation while video content data is being played back, the computer 1 starts a streaming process in order to transfer the video content data, which is currently being received and played back, to the TV 5. In the streaming process, to begin with, the computer 1 captures the video content data decoded by the video playback program (e.g. a stream of video data obtained by the decode and a stream of audio data obtained by the decode), and encodes the captured video data stream and audio data stream. For the encoding, use is made of a codec (encoding scheme) which enables the DMR device (e.g. TV 5) on the network to execute decoding.

The reason why the output of the video playback program (the decoded video data and decoded audio data), and not the video content data received from the video delivery site 2, is captured is that the video content data can easily be converted to video content data which can be played back by the DMR device, without taking care of the kind of the codec applied to the received video content data (i.e. the kind of the encoding scheme of the video data and audio data in the content data). The parse (analysis) of the video content data received from the video delivery site 2 and the process of synchronizing the video data and audio data have already been executed by the video playback program. Thus, the video content data, which can be played back by the DMR device, can easily be generated by simply encoding the output of the video playback program.

The computer 1 instructs the TV 5 via the network 10 to play back the video content data generated by encoding the output of the video playback program. Then, the computer 1 transfers the video content data to the TV 5 via the network 10. In this case, the HTTP protocol or other various general-purpose protocols can be used for the transfer of the video content data from the computer 1 to the TV 5. Responding to a playback instruction from the computer 1, the TV 5 starts a process of receiving the video content data, the playback of which has been instructed, from the computer 1, and decodes the encoded video data and encoded audio data comprised in the received video content data, thereby playing back the decoded video data and audio data.

The video corresponding to the decoded video data is displayed on a display screen 600B of the TV 5. Not the entire image in the window 500A of the browser, but only the video on the video window 500B is displayed on the display screen 600B of the TV 5. Thus, the user can enjoy only the video on the large screen. The sound corresponding to the decoded audio data is produced, for example, from a speaker provided on the TV 5.

If the TV 5 is in the process of viewing of TV broadcast program data, the TV 5 automatically switches the content data, which is the target of viewing, from the broadcast program data to the content data transmitted from the computer 1.

Thus, while searching and playing back the video content on the video delivery site 2 by operating the computer 1, the user can cause the TV 5 to play back the currently received and played-back video content.

In general, since the size of the display screen of the TV 5 is larger than the size of the display screen of the computer 1, the above-described streaming function enables the user or the whole family to view the video content data on the video delivery site 2. The streaming function can be executed by simply operating the computer 1, without operating the TV 5.

Recently, there has been developed a TV having a browser function for accessing sites on the Internet. However, it is not always easy for persons, who are not familiar with the operation of computers, to use the browser function of the TV. Besides, in usual cases, the operability of the browser function of the TV is lower than that of the browser function of the computer.

In the present embodiment, if a person in the family is familiar with the operation of computers, this person may operate the computer 1, thereby making it possible to display the video received from the Internet on the large display screen of the TV 5. Thus, without accessing a WEB site from the TV 5, the family can enjoy the video, which is searched from the Internet 3, by making use of the computer 1 with high operability.

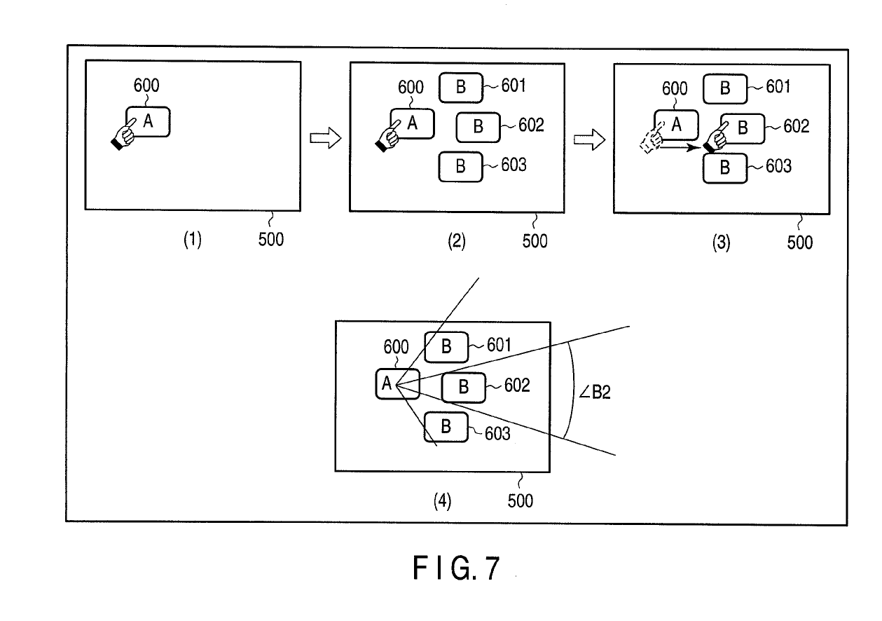

The computer 1 of the embodiment makes use of the above-described streaming function in order to enable the transfer of the video content data to the electronic device by a simple operation. In the state in which the video of the video content data, which is being currently played back, is displayed on the display of the computer 1, a graphical user interface (GUI) for enabling the user to control the streaming function is displayed on the display of the computer 1. The details of the GUI will be described later with reference to FIG. 7 and the following Figures. In brief, a first button and one or more second buttons are displayed on the GUI. The first button is a button indicative of source content data. The currently played-back video content data is associated with the first button as source content data. One or more second buttons indicate one or more electronic devices which can function as destination devices. When a user operation is performed for associating the first button with one or more second buttons, the above-described streaming function is automatically started. Then, the currently played-back video content data that is associated with the first button is transferred to one or more electronic devices.

Thus, while viewing video content data, the user can easily transfer the video content data to the electronic device.

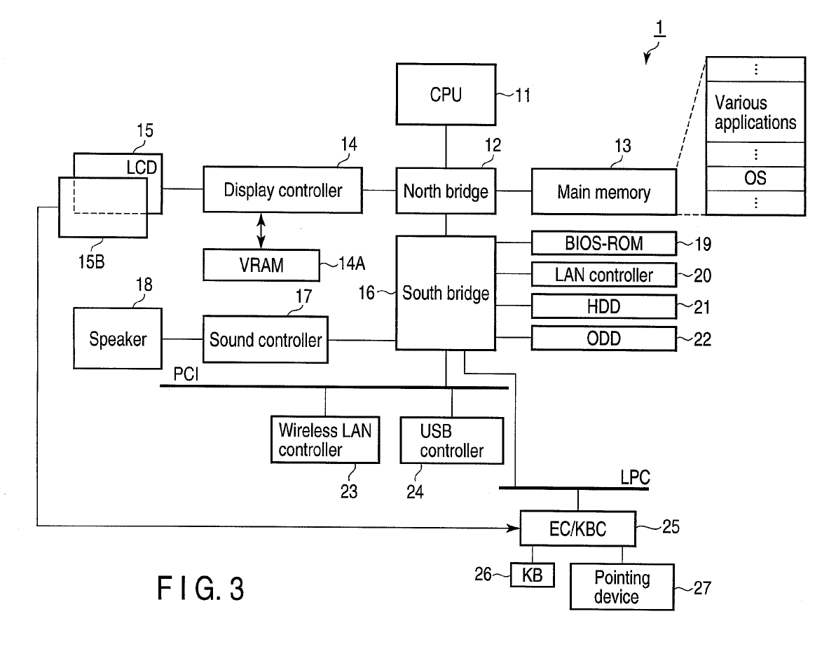

FIG. 3 shows the system configuration of the computer 1.

As shown in FIG. 3, the computer 1 comprises a CPU 11, a north bridge 12, a main memory 13, a display controller 14, a video memory (VRAM) 14A, an LCD (Liquid Crystal Display) 15, a south bridge 16, a sound controller 17, a speaker 18, a BIOS-ROM 19, a LAN controller 20, a hard disk drive (HDD) 21, an optical disc drive (ODD) 22, a wireless LAN controller 23, a USB controller 24, an embedded controller/keyboard controller (EC/KBC) 25, a keyboard (KB) 26 and a pointing device 27.

The CPU 11 is a processor controlling the operation of the computer 1. The CPU 11 executes an operating system (OS) and various application programs loaded from the HDD 21 into the main memory 13. The application programs comprise the above-described browser and video playback program. Further, the application programs comprise the software for executing the above-described streaming function. The CPU 11 also executes a BIOS (Basic Input/Output System) that is stored in the BIOS-ROM 19. The BIOS is a program for hardware control.

The north bridge 12 is a bridge device that connects a local bus of the CPU 11 and the south bridge 16. The north bridge 12 comprises a memory controller that access-controls the main memory 13. The north bridge 12 has a function of executing communication with the display controller 14.

The display controller 14 is a device controlling the LCD 15 that is used as a display of the computer 1. The LCD 15 is realized as a touch screen device which can detect a position touched by a pen or finger. Specifically, a transparent coordinate detection module 15B, which is called “tablet” or “touch panel”, is disposed on the LCD 15.

The south bridge 16 controls the devices on a PCI (Peripheral Component Interconnect) bus and an LPC (Low Pin Count) bus. In addition, the south bridge 16 comprises an IDE (Integrated Drive Electronics) controller for controlling the HDD 21 and ODD 22, and a memory controller for access-controlling the BIOS-ROM 19. Furthermore, the south bridge 16 has a function of communicating with the sound controller 17 and LAN controller 20.

The sound controller 17 is a sound source device, and outputs audio data, which is to be played back, to the speaker 18. The LAN controller 20 is a wired communication device executing wired communication according to, e.g. the Ethernet (trademark) standard. The wireless LAN controller 23 is a wireless communication device executing wireless communication of, e.g. the IEEE 802.11 standard. The USB controller 24 communicates with an external device via a cable of, e.g. the USB 2.0 standard.

The EC/KBC 25 is a one-chip microcomputer in which an embedded controller for power management and a keyboard controller for controlling the keyboard (KB) 26 and pointing device 27 are integrated. The EC/KBC 25 has a function of powering on/off the computer 1 in response to the user's operation.

The computer 1 having the above-described structure operates to download via the Internet the content data, which is provided by the video delivery site 2 shown in FIG. 1, by the programs (OS and various applications) loaded from the HDD 21 into the main memory 13 and are executed by the CPU 11, and to play back the downloaded content data.

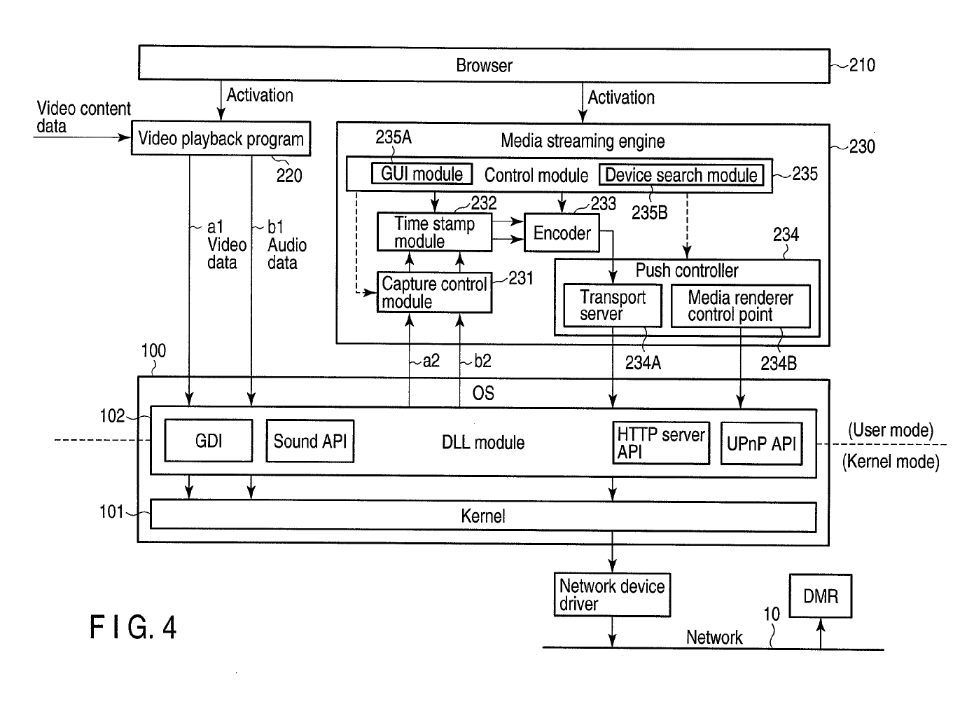

Next, referring to FIG. 4, a description is given of the software configuration used in order to execute the above-described streaming function.

As shown in FIG. 4, an OS 100, a browser 210, a video playback program 220 and a media streaming engine 230 are installed in the computer 1. Each of the video playback program 220 and the media streaming engine 230 is embedded in the browser 210 as plug-in software.

The OS 100, which executes resource management of the computer 1, comprises a kernel 101 and a DLL 102. The kernel 101 is a module controlling the respective components (hardware) of the computer 1 shown in FIG. 2, and the DLL 102 is a module which provides the application program with an interface with the kernel 101. The DLL 102 comprises a GDI (graphical device interface) which is an API relating to a graphics process, a sound API which is an API relating to a sound process, an HTTP server API, and an UPnP-API.

When the browser 210 accesses the Web page of the video delivery site 2, the browser 210 detects, according to the tag information in this Web page, that the Web page is a Web page comprising content such as video. Then, the browser 210 starts the video playback program 220 which is incorporated in the browser 210 as plug-in software. If the user performs an operation of instructing the playback of content, such as video, while viewing the Web page, the video playback program 220 begins to receive the video content data from the video delivery site 2.

The video playback program 220, while receiving the video content data, decodes in parallel the video data and audio data comprised in the video content data. The video playback program 220 delivers to the DLL 102 of the OS 100 a stream al of video data obtained by the decoding and a stream b1 of audio data obtained by the decoding, thereby to enable video output (by the LCD 15) and audio output (by the speaker 18).

In usual cases, the video data al and audio data b1, which are delivered to the DLL 102, are subjected to a process of, e.g. a format check in the DLL 102, and then the processed data are supplied to the kernel 101. The kernel 101, based on the supplied data, executes video output from the LCD 15 and audio output from the speaker 18. The format check and other various processes on the video data al may be executed by, e.g. the GDI, and the format check and other various processes on the audio data b1 may be executed by, e.g. the sound API.

The media streaming engine 230 is a program which is plugged in the browser 210 as resident plug-in software. In accordance with the start-up of the browser 210, the media streaming engine 230 is automatically activated. In order to execute the above-described streaming function, the media streaming engine 230 has the following functions:

1. A function for searching a DMR device on the network 10 (DMR device is an electronic device which can play back video content data received from an external device such as a DMS);

2. A function for capturing an output of the video playback program 220 via the DLL 102;

3. A function for encoding the captured video data and audio data by an encoding scheme such as MPEG-2 or WMV; and

4. A function for transferring video content data comprising the encoded video data and encoded audio data to the DMR device such as TV 5.

In order to realize these functions, the media streaming engine 230 comprises a capture control module 231, a time stamp module 232, an encoder 233, a push controller 234 and a control module 235.

The capture control module 231 captures the video data al and audio data b1 which are output from the video playback program 220. Since the video playback program 220 outputs the video data a1 and audio data b1 to the OS 100, the capture control module 231 can capture, via the OS 100, the video data a1 and audio data b1 which are output from the video playback program 220. For example, the capture may be executed by rewriting a part of the routine in the DLL 102. In this case, the routine in the DLL 102, which handles the video data a1 and audio data b1, may be rewritten to a new routine which additionally comprises a procedure for delivering copy data of the video data a1 and audio data b1 to the media streaming engine 230. This new routine delivers the video data a1 and audio data b1, which are output from the video playback program 220, to the kernel 101, and also delivers video data a2 and audio data b2, which are copies of the video data a1 and audio data b1, to the media streaming engine 230.

For example, when the media streaming engine 230 is activated, the capture control module 231 asks the browser 210 to notify the media streaming engine 230 of the start of the video playback program 220. When this notification is received, the capture control module 231 executes rewrite of the routine in the DLL 102 (e.g. a part of the GDI, a part of the sound API, etc.).

In the meantime, a software module, which can execute a first function of (i) delivering the video data a1 and audio data b1 to the kernel 101 and a second function of (ii) capturing the video data a1 and audio data b2 and delivering the captured video data and audio data to the media streaming engine 230, may be provided in the DLL 102 in advance, and the enable/disable of the second function may be controlled by the capture control module 231 of the media streaming engine 230.

By the above-described function of the capture control module 231, the time stamp module 232 can receive the video data a2 and audio data b2 from the DLL 102. The time stamp module 232 is a module adding time information indicative of the timing, at which the video data a2 and audio data b2 are received, to the video data a2 and audio data b2. The video data a2 and audio data b2, to which the time information has been added by the time stamp module 232, are delivered to the encoder 233. The encoder 233 encodes the video data a2 and audio data b2. Based on the time information added by the time stamp module 232, the encoder 233 multiplexes the encoded video data and encoded audio data, thereby generating video content data comprising a bit stream in which the encoded video data and encoded audio data are multiplexed.

The push controller 234 instructs, via the network 10, the DMR device (e.g. TV 5) to play back the video content data generated by the encoder 233, and transfers the video content data to the DMR device (e.g. TV 5) via the network 10. The push controller 234 comprises a transport server 234A and a media renderer control point 234B. The media renderer control point 234B is a module functioning as the above-described DMC, and transmits via the network 10 to the DMR device a control message which instructs playback of the video content data generated by the encoder 233. This control message is sent to the DMR device (e.g. TV 5) via the OS 100, a network device driver and the network 10. The transport server 234A is a module transmitting the video content data, which is generated by the encoder 233, to the DMR device (e.g. TV 5). The transmission of the content data is executed, for example, by using communication between the HTTP-API in the DLL 102 and the DMR device (e.g. TV 5).

The control module 235 controls the respective elements in the media streaming engine 230. The control module 235 displays a graphical user interface on the touch screen (the screen of the LCD 15), and controls, according to an operation of the graphical user interface by the user, the start and stop of the transfer of the video content data to the TV 5, or, to be more specific, the start and stop of the streaming function.

The control module 235 comprises a graphical user interface (GUI) module 235A and a device search module 235B. The device search module 235B executes, in cooperation with the UPnP-API in the DLL 102, a process for searching (discovering) a DMR device on the network 10. The graphical user interface (GUI) module 235A displays on the touch screen (the screen of the LCD 15) a GUI for enabling the user to control the above-described streaming function, and controls the execution of the streaming function in accordance with the user's operation on the GUI. The user operates the pointing device 27 or performs a touch operation on the touch screen by the finger, thus being able to give an instruction for controlling the streaming function (e.g. an instruction to start/end steaming, or an instruction to select the DMR device) to the media streaming engine 230.

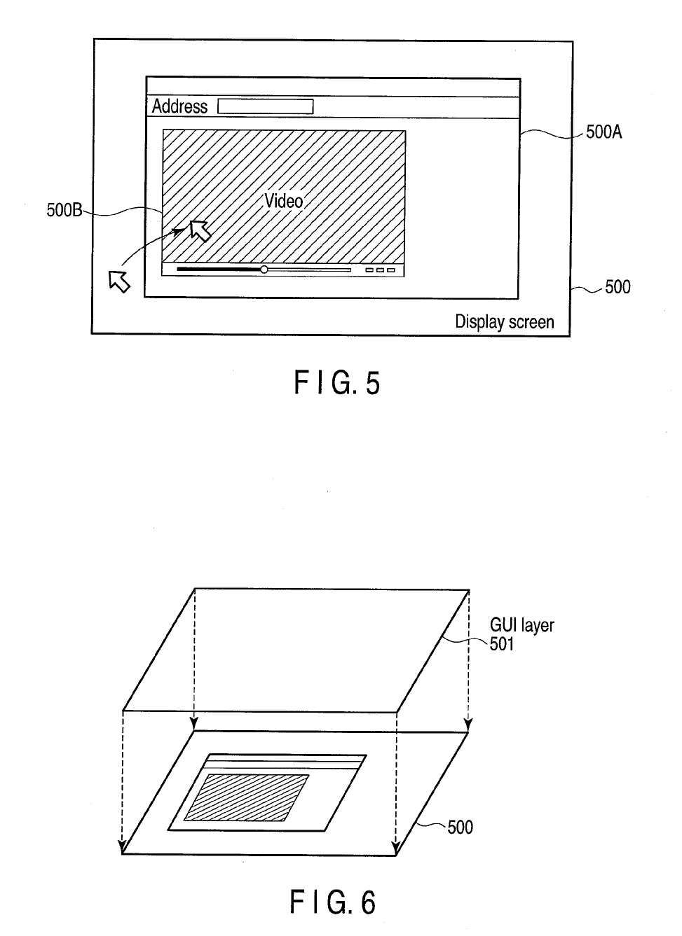

Next, referring to FIG. 5 to FIG. 14, an example of the GUI for enabling the user to control the streaming function is described.

FIG. 5 shows an example of a display screen (desktop screen) 500 of the LCD 15 of the computer 1. A window 500A of the browser 210 is displayed on the display screen 500 of the computer 1. If the playback of video is started by the video playback program 220, a moving image corresponding to the video is displayed on a video window 500B disposed in the window 500A. When a mouse cursor is moved onto the video window 500B according to the user's operation of the pointing device 27, or when a position on the video window 500B is touched by the finger, the graphical user interface (GUI) module 235A starts display of the GUI. As shown in FIG. 6, a layer 501, which is different from the display screen 500, is used for the display of the GUI. The GUI layer 501 has the same size as the display screen 500. The graphical user interface (GUI) module 235A displays the above-described GUI on the display screen 500 by rendering an object, such as an icon (button), on the GUI layer 501. In the GUI layer 501, the entire area excluding an area, where the object, such as an icon, is rendered, is set to be transparent so that the content of the display screen 500 can be viewed. By using the GUI layer 501, the object, such as an icon, for the GUI can be displayed on the video window 500B or window 500A, or on the outside of the window 500A.

Next, the GUI control, which is used in the embodiment, is described with reference to FIG. 7.

Such a situation is now assumed that when one button A is selected by the user, a plurality of buttons B are further displayed, and one of the plurality of buttons B is selected by the user's operation. In usual cases, the user first selects the button A by operating the pointing device 27 or by performing a touch operation on the touch screen by the finger. Thereafter, the user selects the button B. In this case, two click operations are required. In addition, when the touch screen is manipulated by the finger, it is necessary to press the button twice. Furthermore, both in the first pressing of the button and the second pressing of the button, it is necessary to perform the pressing operation by exactly positioning the finger on the associated button.

In the present embodiment, the buttons A and B can be selected by operations other than the above-described operations. Assuming the case of manipulating the touch screen by the finger, a description is given below of how the control module 235 operates in accordance with the button operation by the finger.

1. The user presses a first button (A) 600 by the finger, which is displayed on the display screen 500 of the touch screen device ((1) in FIG. 7).

2. The control module 235 recognizes that the first button (A) 600 has been pressed, and displays a plurality of second buttons (B) 601, 602 and 603 in the vicinity of the first button (A) 600 on the display screen 500 ((2) in FIG. 7).

3. The user, while keeping the finger in contact with the display screen 500, slides the position of the finger from the position on the display screen 500, which corresponds to the first button (A) 600, toward the second button (B) 601, 602, or 603, and then releases the finger from the display screen 500 ((3) in FIG. 7).

4. The control module 235 selects one of the second buttons (B) 601, 602 and 603 in accordance with the position from which the finger is released, or in other words, in accordance with the direction of the slide of the position of the finger (the direction of the slide of the pointing position). The control module 235 transfers the currently played-back video content data to the electronic device corresponding to the selected second button (B). For example, if the position of the finger (the pointing position) is slid from the first button (A) 600 toward the area on the display screen 500 which corresponds to the second button (B) 601, the control module 235 selects the second button (B) 601. The currently played-back video content data is transferred to the electronic device corresponding to the second button (B) 601. In addition, for example, if the position of the finger (the pointing position) is slid from the first button (A) 600 toward the area on the display screen 500 which corresponds to the second button (B) 602, the control module 235 selects the second button (B) 602. The currently played-back video content data is transferred to the electronic device corresponding to the second button (B) 602.

In the conventional drag & drop method, it is necessary for the user to exactly slide the finger onto one of the buttons (B). In the present embodiment, however, one of the buttons (B) can be selected in accordance with the direction of slide of the pointing position. Thus, the operability of the GUI using the touch screen can be improved.

In addition, also by the repetition of an ordinary click operation, one of the buttons (B) can be selected. For example, the user performs operations of pressing and releasing the button (A) 600, and then pressing and releasing one of the buttons (B) 601, 602 and 603 which are displayed subsequently. In this case, too, one of the buttons (B) can be selected.

Although the manipulation by the finger has been described by way of example, the GUI control of the embodiment is applicable to the operations of pointing devices such as a mouse and a touch pad.

The GUI control, by which one of the buttons (B) is selected in accordance with the direction of slide of the pointing position, can be realized by setting detection areas (also referred to as “drop areas”) corresponding to the respective buttons (B), as shown in part (4) in FIG. 7. Specifically, in the embodiment, three detection areas, which extend from the button (A) 600 toward the buttons (B) 601, 602 and 603, are defined. These three detection areas are defined so as not to overlap each other. The buttons (B) 601, 602 and 603 are displayed in a peripheral area of the button (A) 600, and this peripheral area is divided into three detection areas extending from the button (A) 600 toward the buttons (B) 601, 602 and 603. For example, the detection area corresponding to the button (B) 602 has a fan shape (central angle=B2) extending from the center of the button (A) 600 toward the button (B) 602.

Responding to the sliding movement of the pointing position on the screen from the button (A) 600 to one of the three detection areas, the control module 235 transfers the currently played-back video content data to the electronic device indicated by the button (B) that is associated with the detection area to which the pointing position has been slid. Accordingly, the user can select a target second button (B) by simply sliding the finger from the position of the button (A) 600 toward the target second button (B). For example, as regards the second button (B) 602, the user may slide the position of the finger from the button (A) 600 to the right.

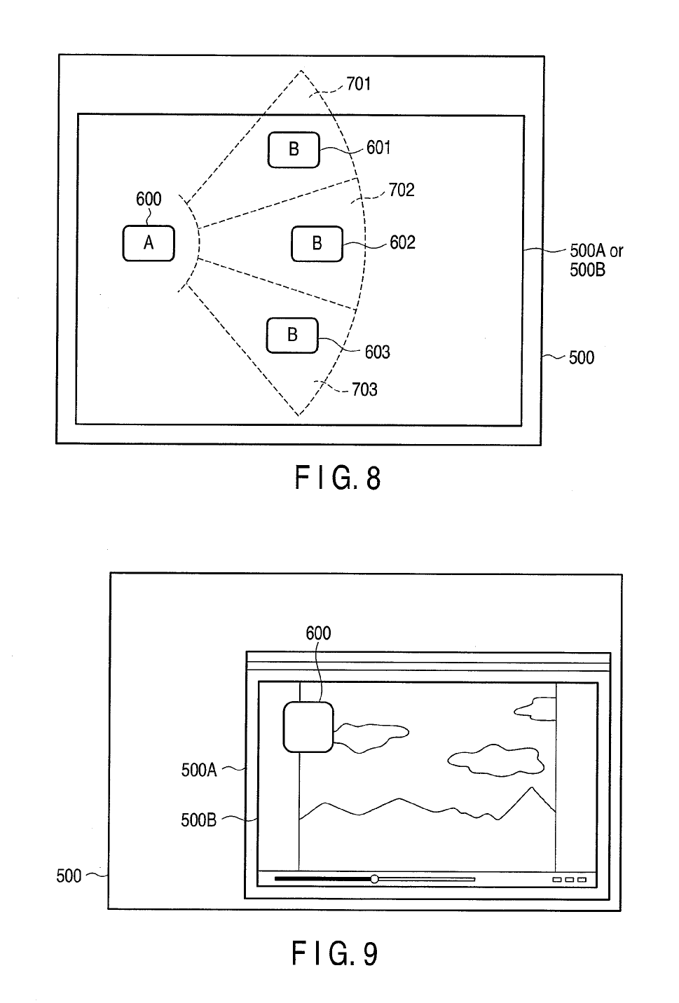

FIG. 8 shows examples of detection areas 701, 702 and 703 corresponding to the buttons (B) 601, 602 and 603. The detection areas 701, 702 and 703 can be obtained by dividing the region surrounding the buttons (B) 601, 602 and 603 into three areas.

The detection area 701 is a detection area corresponding to the button (B) 601, and this detection area 701 extends from the position on the display screen 500 corresponding to the button (A) 600 to the position on the display screen 500 corresponding to the button (B) 601. In other words, the detection area 701 comprises at least an area on the display screen 500, which extends along a line connecting the button (A) 600 and the button (B) 601.

The detection area 702 is a detection area corresponding to the button (B) 602, and this detection area 702 extends from the position on the display screen 500 corresponding to the button (A) 600 to the position on the display screen 500 corresponding to the button (B) 602. In other words, the detection area 702 comprises at least an area on the display screen 500, which extends along a line connecting the button (A) 600 and the button (B) 602.

The detection area 703 is a detection area corresponding to the button (B) 603, and this detection area 703 extends from the position on the display screen 500 corresponding to the button (A) 600 to the position on the display screen 500 corresponding to the button (B) 603. In other words, the detection area 703 comprises at least an area on the display screen 500, which extends along a line connecting the button (A) 600 and the button (B) 603.

The user, while keeping the finger in contact with the display screen 500, slides the position of the finger from the position on the display screen 500 corresponding to the first button (A) 600 toward the second button (B) 601, 602 or 603, and then releases the finger from the display screen 500. The control module 235 determines which of the detection areas 701, 702 and 703 the position (drop position), from which the finger has been released, belongs to, and selects the second button (B) having the detection area to which the drop position belongs.

Next, the procedure of a GUI display process, which is executed by the control module 235, is described.

When the mouse cursor is moved onto the video window 500B or when an area on the touch screen, which corresponds to the display position of the video window 500B, is touched by the finger, the graphical user interface (GUI) module 235A of the control module 235 displays, as shown in FIG. 9, a first button (first icon) 600 on the display screen 500, for example, on the video window 500B. The first button 600 is used in order to notify the user that an operation of video on the video window 500B (in this example, the execution of the streaming function) can be performed. The first button 600, as described above, is associated with the video currently played back on the video window 500B.

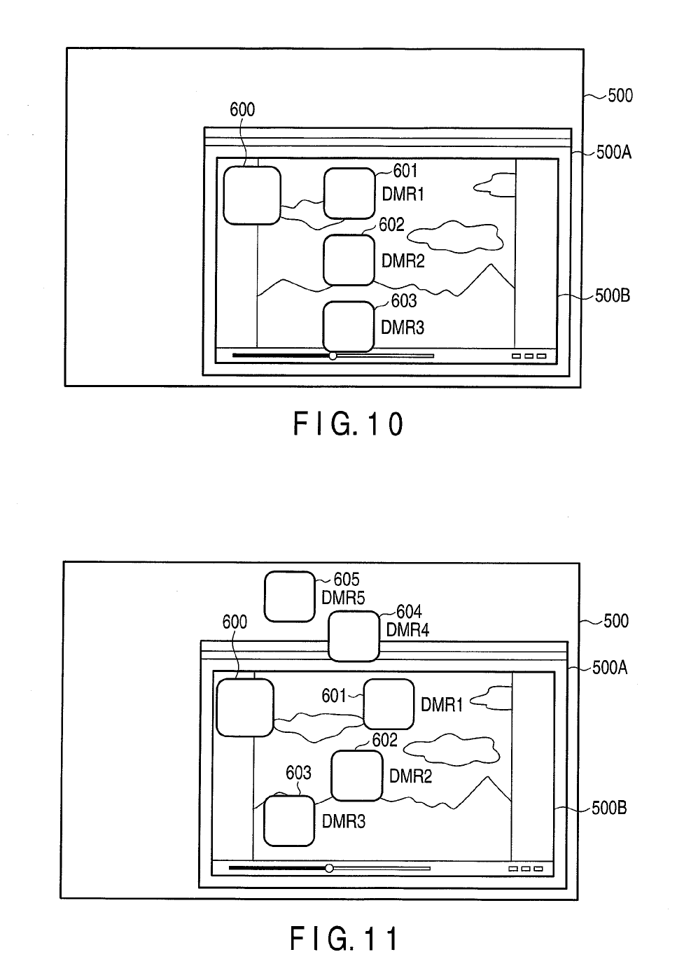

When the first icon 600 is selected by the user's touch operation or by the operation of the pointing device, the device search module 235B of the control module 235 searches a DMR device on the network 10. Then, as shown in FIG. 10, the graphical user interface (GUI) module 235A displays second buttons (second icons), which indicate all DMR devices discovered by the search process, on the display screen 500, for example, on the video window 500B. In FIG. 10, the case is assumed in which three DMR devices DMR1, DMR 2 and DMR3 have been discovered. In this case, three second buttons 601, 602 and 603, which are associated with the three DMR devices, are displayed near the first button 600. Each second icon is accompanied with a text field indicating the name of the DMR device corresponding to the associated second button. By performing a touch operation or an operation of the pointing device, for example, by performing a pointing operation such as drag & drop, the user can associate the first button 600 with any one of the second buttons 601, 602 and 603. The control module 235 selects, as a destination device, the DMR device indicated by the second button associated with the first button 600. The capture and encode of the video data, which is currently played back on the video window 500B, are started, and the encoded video data is automatically transmitted to the DMR device which has been selected as the destination device.

FIG. 11 shows another display example of the second buttons.

In FIG. 11, the case is assumed in which five DMR devices DMR1, DMR2, DMR3, DMR4 and DMR5 have been discovered. Five second buttons 601, 602, 603, 604 and 605, which are associated with the five DMR devices, are displayed along an arc having the center at the first button 600, as shown in FIG. 11.

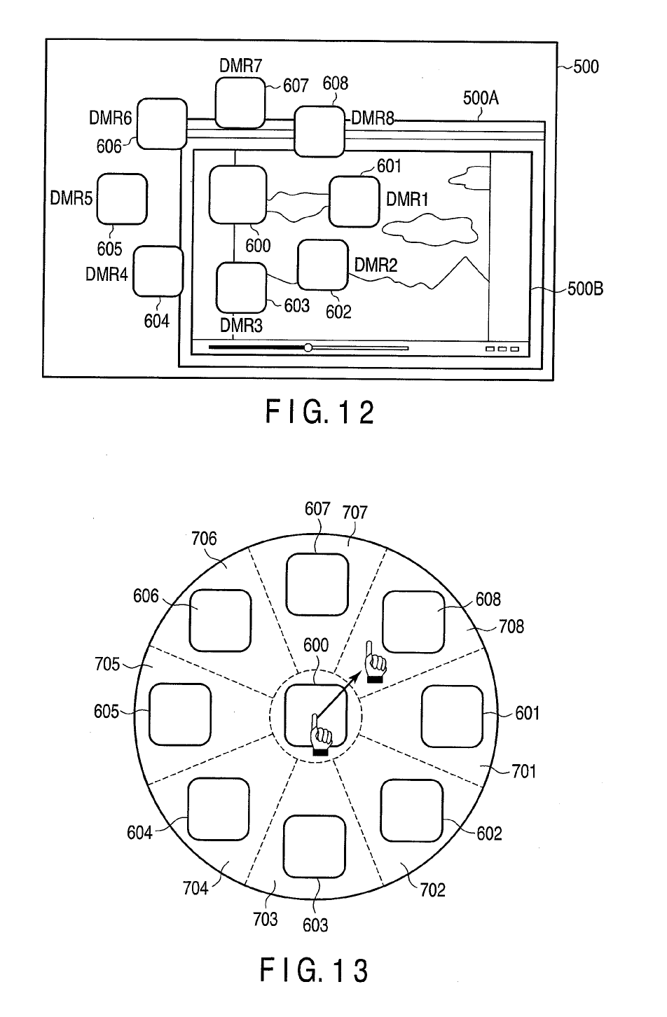

FIG. 12 shows still another display example of the second buttons.

In FIG. 12, the case is assumed in which eight DMR devices DMR1 to DMR8 have been discovered. Eight second buttons 601 to 608, which are associated with the eight DMR devices, are displayed in a manner to surround the first button 600, as shown in FIG. 12. For example, the second buttons 601 to 608 are displayed along a concentric circle having the center at the first button 600.

FIG. 13 shows an example of detection areas corresponding to the second buttons 601 to 608 shown in FIG. 12.

An area surrounding the first button 600, for example, a concentric circle having the center at the first button 600, is divided into eight detection areas 701 to 708 corresponding to the second buttons 601 to 608. The second buttons 601 to 608 are displayed around the first button 600 when the user has pressed the first button 600 by the finger. While keeping the finger in contact with the display screen 500, the user slides the position of the finger from the position on the display screen 500, which corresponds to the first button 600, for example, toward the second button 608, and then releases the finger from the display screen 500 (drag & drop). In this case, since the drop position falls within the detection area 708, the second button 608 is selected. In the meantime, in accordance with the drag operation, that is, in accordance with the slide of the position of the finger, the position of the first button 600, which is displayed on the display screen 500, may be moved.

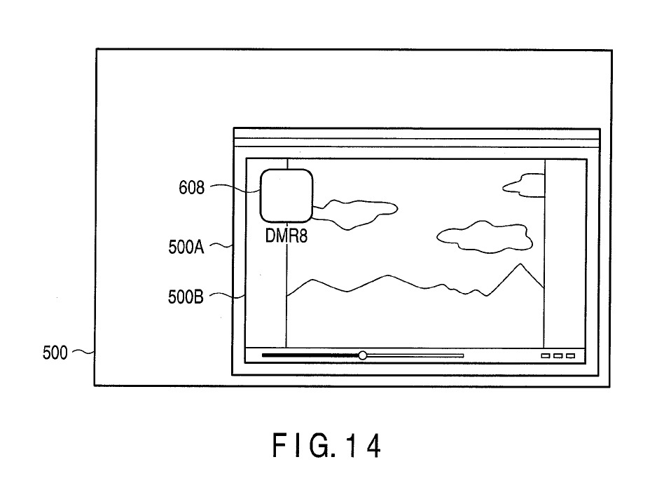

If the second button 608 is selected, as shown in FIG. 14, the first button 500 and the second buttons, other than the selected second button 608, are caused to disappear from the display screen 500, and only the selected second button 608 is displayed on the display screen 500. The display state of FIG. 14 indicates that video content data is being transferred to the DMR 8 represented by the second button 608. If the second button 608 is selected by the user once again, the transfer of the video content data to the DMR 8 is halted.

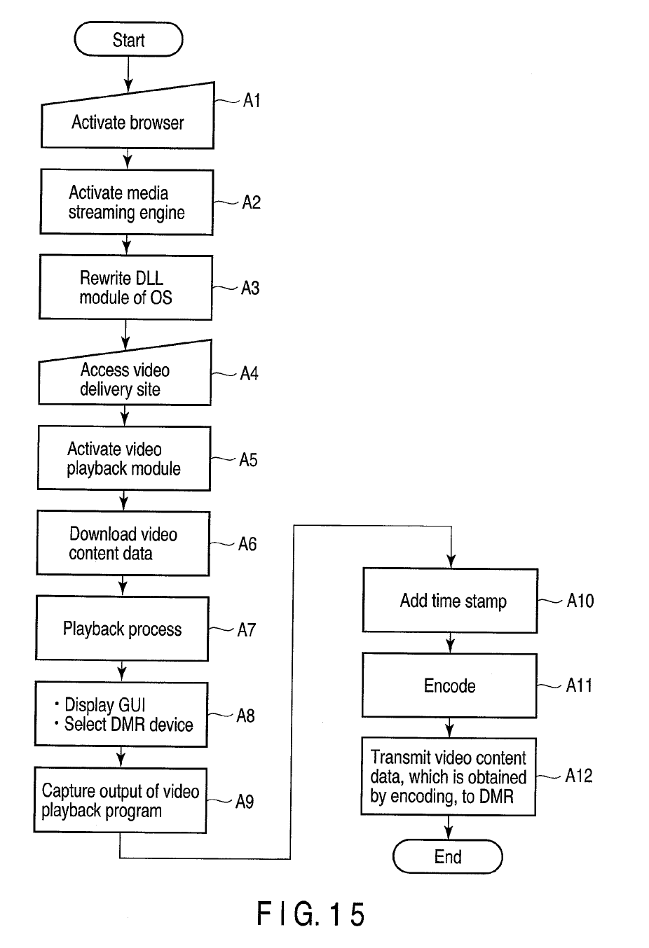

Next, referring to a flow chart of FIG. 15, a description is given of the procedure of the streaming process executed by the computer 1 of the embodiment.

When the browser 210 is started by a user operation (step A1), the browser 210 first loads the media streaming engine 230 in the memory 13 and starts the media streaming engine 230 (step A2). In step A2, the media streaming engine 230 is loaded in the memory 13 and executed. The capture control module 231 of the media streaming engine 230 executes, for example, rewrite of the DLL 102 of the OS 100, in order to acquire video data and audio data (step A3).

If the user views a Web page of the video delivery site 2 by the browser 210 (step A4), the browser 210 starts the video playback program 220 embedded in the browser 210 as plug-in software (step A5). If the user performs an operation to instruct the start of playback of certain video content data on the Web page, the video playback program 220 starts download of this video content data (step A6). While downloading the video content from the video delivery site 2, that is, while receiving the video content from the video delivery site 2, the video playback program 220 plays back the video content data (step A7). In the playback process, the video playback program 220 extracts the encoded video data and encoded audio data from the video content data, and decodes the encoded video data and encoded audio data. The decoded video data and decoded audio data are sent to the OS 100. Video corresponding to the decoded video data is displayed on the video window 500B disposed in the window 500A of the browser 210.

When the mouse cursor is moved onto the video window 500B by the user operation, or when the video window 500B is touched by the finger, the media streaming engine 230 displays the above-described GUI on the display screen 500, and selects the DMR device, which is to be set as the destination device, in accordance with the user's operation of the GUI (step A8). In step A8, the media streaming engine 230 first displays the first button (first icon) 600 on the display screen 500. If the first icon 600 is selected by the user, the media streaming engine 230 searches a DMR device on the network by using the UPnP function. The media streaming engine 230 displays second buttons (second icons) on the display screen 500 in association with discovered DMR devices, respectively. If the user associates the first button 600 with one of the second buttons by, e.g. a drag & drop operation, the media streaming engine 230 selects the DMR device corresponding to the associated second button as the destination external device.

The media streaming engine 230 starts capturing video data and audio data which are output from the video playback program 220 (step A9). The media streaming engine 230 adds time information to the captured video data and audio data (step A10), and encodes the captured video data and audio data, thereby generating video content data which can be decoded by the selected DMR device (step A11). The media streaming engine 230 instructs the selected DMR device to play back the generated video content data, and transmits the generated video content data to the selected DMR device (step A12).

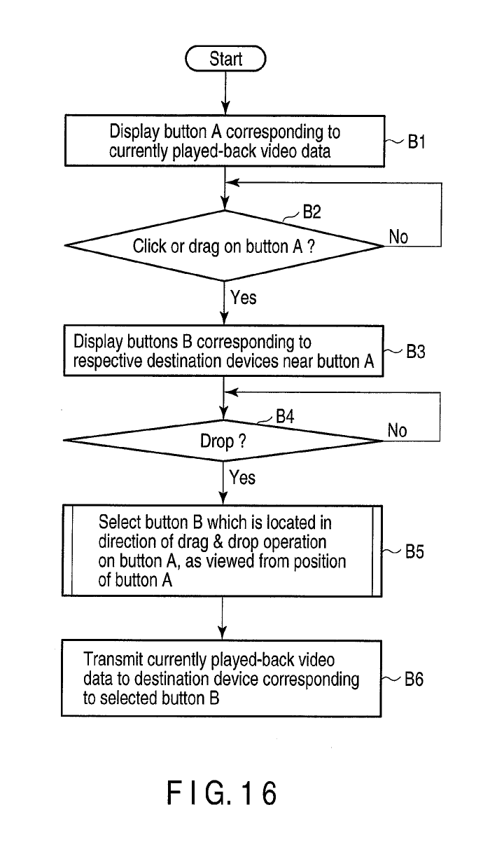

Next, referring to a flow chart of FIG. 16, the procedure of the GUI control operation, which is used in the embodiment, is described.

When the mouse cursor is moved onto the video window 500B or when an area on the touch screen, which corresponds to the display position of the video window 500B, is touched by the finger, the control module 235A displays the first button A, which is associated with the currently played-back video content data, on the display screen 500, for example, on the video window 500B (step B1). When the first button A is selected by the user's touch operation or by the operation of the pointing device (click of first button A, drag of first button A, etc.) (YES in step B2), the device search module 235B of the control module 235 searches a DMR device on the network 10. Then, the graphical user interface (GUI) module 235A displays second buttons B, which indicate all DMR devices discovered by the search process, on the peripheral area of the first button A (step B3).

The user slides the pointing position from the first button A toward a certain second button B in the state in which the first button A is selected. The operation of sliding the pointing position is also called “draw operation”. Responding to the separation of the finger from the display screen or the release of the left button of the mouse, the control module 235 determines whether the draw operation has been completed, that is, whether the drop operation has been performed (step B4).

If the drop operation has been performed (YES in step B4), the control module 235 selects, from among the plural second buttons, the second button B present in the direction of the slide of the pointing position from the first button A (step B5). Then, the control module 235 transfers the currently played-back video content data to the DMR indicated by the selected second button B (step B6).

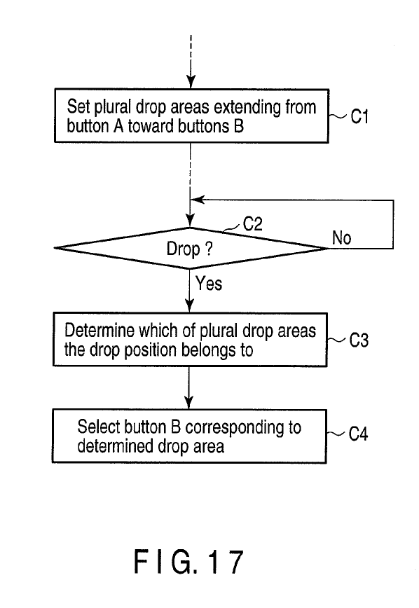

Next, referring to a flow chart of FIG. 17, a description is given of an example of the procedure of the process for selecting the second button B, which is executed in step B5 in FIG. 16.

The control module 235 sets a plurality of detection areas (drop areas) which extend from the position on the display screen 500 corresponding to the first button A to the positions on the display screen 500 corresponding to the plural second buttons B, and which do not overlap each other (step C1). Then, if a drop operation is performed (YES in step C2), the control module 235 determines which of the plural drop areas the drop position belongs to (step C3), and selects the second button B corresponding to the determined drop area (step C4).

As has been described above, according to the present embodiment, the GUI is displayed on the display in the state in which the video of the currently played-back video content data is being displayed on the display. The GUI displays the first button and one or more second buttons. The currently played-back video content data is associated, as the source content data, with the first button A. The one or more second buttons are indicative of one or more electronic devices which can function as destination devices. When a user operation is performed for associating the first button with one or more second buttons, the streaming function is automatically started. Then, the currently played-back video content data that is associated with the first button is transferred to the electronic device indicated by the second button that is associated with the first button. Thus, while viewing video content data, the user can easily transfer the video content data to the electronic device, where necessary.

In the embodiment, the case has been described, by way of example, in which the encoded video content data received from the server such as a video delivery site is transferred to the electronic device. Alternatively, in accordance with the user's operation on the GUI displayed while the video content data stored in the storage device of the computer 1 is being played back, the played-back video content data may be captured and the captured video content data may be transferred to the electronic device.

The data transfer of the embodiment is realized by the computer program. Thus, the same advantageous effects as with the present embodiment can easily be obtained simply by installing the computer program into an ordinary computer through a computer-readable storage medium storing the computer program, and executing the computer program.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus configured to play back video content data, comprising:
a display device configured to display video of video content data being played back; and
a control module configured to display a graphical user interface comprising a first button associated with the video content data being played back and a second button indicative of an electronic device on a screen of the display device, and to transfer the video content data, which is associated with the first button and is being played back, to the electronic device in response to a pointing operation by a user for associating the first button with the second button.

2. The information processing apparatus of claim 1, wherein the control module is configured to transfer the video content data being played back to the electronic device, responding to sliding of a pointing position on the screen from the first button to a detection area associated with the second button, and the detection area extends from a position on the screen corresponding to the first button to a position on the screen corresponding to the second button.

3. The information processing apparatus of claim 1, wherein the control module is configured to display the first button on the screen, to display the second button on the screen in response to pointing of the first button, and to transfer the video content data being played back to the electronic device in response to sliding of a pointing position on the screen from the first button to a detection area associated with the second button, and the detection area extends from a position on the screen corresponding to the first button to a position on the screen corresponding to the second button.

4. An information processing apparatus configured to play back video content data, comprising:
a display device configured to display video of video content data being played back;
a search module configured to search electronic devices configured to play back video content data received from an external device; and
a control module configured to display on a screen of the display device a first button, which is associated with the video content data being played back, and a plurality of second buttons indicative of electronic devices which have been searched, and to transfer, responding to sliding of a pointing position on the screen from first button to one of a plurality of detection areas associated with the plurality of second buttons, the video content data being played back to the electronic device indicated by the second button associated with the one of the detection areas, and the plurality of detection areas extend from a position on the screen corresponding to the first button to positions on the screen corresponding to the plurality of second buttons such that the plurality of detection areas do not overlap each other.

5. The information processing apparatus of claim 4, wherein the control module is configured to display the first button on the screen, to display the plurality of second buttons on the screen in response to pointing of the first button, and to transfer, responding to sliding of a pointing position on the screen from the first button to one of the plurality of detection areas, the video content data being played back to the electronic device indicated by the second button associated with the one of the plurality of detection areas.

6. A data transfer method comprising:
playing back video content data;
displaying, on a screen of a display device, video of video content data being played back; and
displaying a graphical user interface comprising a first button associated with the video content data being played back and a second button indicative of an electronic device on the screen, and transferring the video content data, which is associated with the first button and is being played back, to the electronic device in response to a pointing operation by a user for associating the first button with the second button.

7. The data transfer method of claim 6, wherein the transferring comprises transferring the video content data being played back to the electronic device, responding to sliding of a pointing position on the screen from the first button to a detection area associated with the second button, and the detection area extends from a position on the screen corresponding to the first button to a position on the screen corresponding to the second button.

8. The data transfer method of claim 6, wherein said displaying the graphical user interface comprises displaying the first button on the screen, and displaying the second button on the screen in response to pointing of the first button, and
the transferring comprises transferring the video content data being played back to the electronic device, responding to sliding of a pointing position on the screen from the first button to a detection area associated with the second button, and the detection area extends from a position on the screen corresponding to the first button to a position on the screen corresponding to the second button.
